(19) United States
(12) Patent Application Publication
(10) Pub. No.: US 2017/0282467 A1
(43) Pub. Date: Oct. 5, 2017

(54) COMPOSITE MATERIALS COMPRISING CELLULOSE FILAMENTS AND FILLERS AND METHODS FOR THE PREPARATION THEREOF

(71) Applicant: FPInnovations, Pointe-Claire (CA)

(72) Inventors: Annie DORRIS, Montréal (CA); Gilles DORRIS, Laval (CA); Josée DESMEULES, Montréal (CA); Otman OULANTI, Montréal (CA); Danielle GAGNÉ, Pierrefonds (CA); Norayr GURNAGUL, Saint-Hubert (CA)

(21) Appl. No.: 15/476,334

(22) Filed: Mar. 31, 2017

Related U.S. Application Data
(60) Provisional application No. 62/317,962, filed on Apr. 4, 2016.

(51) Int. Cl. B29C 70/48; D21H 19/28; D21H 19/24; C08J 5/04; D21H 17/67

(52) U.S. Cl. CPC B29C 70/48; C08J 5/045; D21H 17/67; D21H 19/24; D21H 19/28; C08J 2401/02; C08J 2497/02; C08J 2300/00; B29K 2201/00

(57) ABSTRACT

The present disclosure relates to composite materials comprising a resin and at least one sheet that comprise optionally cellulose filaments (CF), fillers and optionally reinforcing fibers as well as methods for the preparation thereof. The methods comprise impregnating the sheets comprising the cellulose filaments, fillers and optionally the reinforcing fibers or a stack thereof with resin. The composite materials can optionally comprise at least one other sheet, the at least one other sheet being different from the at least one sheet and comprising fibers chosen from wood pulp, fiberglass, natural fibers and mixtures thereof. The sheet can also be in the form of a panel of a preform.

### CROSS-REFERENCE TO RELATED APPLICATIONS

The present application claims the benefit of priority from co-pending U.S. provisional application No. 62/317,962 filed on Apr. 4, 2016, that is incorporated herein by reference in their entirety.

### FIELD

The present disclosure relates to composite materials and methods for the preparation thereof. For example, the present disclosure relates to composite materials comprising a resin and at least one sheet, the at least one sheet comprising cellulose filaments (CF), fillers and optionally reinforcing fibers. The composite materials can optionally comprise at least one other sheet, the at least one other sheet being different from the at least one sheet and comprising fibers chosen from but not limited to wood pulp, fiberglass, carbon, aramid, natural fibers and mixtures thereof.

### BACKGROUND

Fillers have been added to materials, for example, to lower their cost as fillers are generally inexpensive and available in large volumes. However, cost reduction is not the only reason for their use as fillers can also provide other attributes to formulations. For example, fillers can also be used, for example, to vary the density, to modify the mechanical, electrical and/or magnetic properties, to impart fire retardancy, and/or to facilitate processing of a material.

As the filler is often the cheapest constituent of a composite, compounders may, for example, have a strong incentive to maximize their content without sacrificing material performance. However, fillers are known to hamper tension and flexural properties of composites.

In bulk molding compounds (BMC) or composite laminates such as sheet molding compounds (SMC), for example, 40 to 65 wt % of inorganic fillers, based on the total weight of the BMC or SMC have been incorporated in a blend of resin and a reinforcing agent such as glass fibers.

In fire-proofing applications, incorporating fillers in a composite has been a challenging task as fillers must be used in large quantities to improve fire-retardancy efficiency. This may, for example, deteriorate mechanical properties and makes processing more difficult because of increased viscosity. Reducing filler loading is possible when using finer particles, although this has been observed to thicken resins which affects processing. For example, very viscous resins have been found, for example, to be disadvantageous to hand lamination, pultrusion, resin transfer molding (RTM) and other processes commonly used in the preparation of composite materials (Rothon, R., Particulate-Filled Polymer Composites (2^{nd} ed.), Ch. 6., Shrewsbury, GBR: Smithers Rapra 2003).

In liquid compression molding (LCM) technologies such as resin transfer molding (RTM) or infusion, the fillers are added to the resin to form a mixture that is injected or infused through fiber mats under vacuum. During processing, the injected liquid mixture replaces the air voids as the front flow propagates under vacuum. The presence of fillers in the mixture tends to complicate processability, for example, because they drastically increase the viscosity of the mixture which causes uneven filler distribution within the composite. This also leads to non-uniform impregnation of the mats, creating dry spots and voids which deteriorate mechanical properties. Specific combinations of mats (fiberglass mat with polypropylene flow media core) and low filler contents (about 25%) are, for example, used to facilitate resin injection. André C. G, Influence of calcium carbonate on RTM and RTM light processing and properties of molded composites, Journal of Reinforced Plastics and Composites 30 (14), 2011.

Large quantities of mineral fillers are also used, for example, in the preparation of electric insulation materials. For example, inorganic fillers are used to improve the physical characteristics, moisture resistance, heat resistance and/or thermal conductivity of the cured product. For example, inorganic fillers are used to decrease the coefficient of thermal expansion of the cured product such as electrical insulation materials that naturally undergo thermal expansion or shrinkage due to heat cycles. For example, the difference in coefficient of thermal expansion between metallic parts (which have a naturally low coefficient) and a thermosetting resin (which has a higher coefficient) is the principal cause of peeling and cracking at joints between these two materials. Therefore, a relatively high amount of inorganic filler is used to lower the coefficient of the resin to a useful value. However, high filler content has been known to reduce flow properties by increasing the resin viscosity which, in turn, makes it more difficult for casting and pressure molding operations. Thus, obtaining a mixing ratio of inorganic powder to resin higher than 50% by volume has been a challenge.

Known methods to improve the flow properties of a thermosetting resin formulation filled with a high filler content have included using a specific ratio of powdered inorganic fillers having various sizes as disclosed in U.S. Pat. No. 3,658,750 (1972) to Michio Tsukui et al. Rheology modifiers have also been used to reduce the viscosity. However, even if they are effective at improving processing, they may, for example, be detrimental to other desired properties.

### SUMMARY

It would thus be desirable to be provided, for example, with a composite material and/or a method of preparation thereof that would at least partially address one of the problems mentioned or that would be an alternative to the known composite materials and/or methods of preparation thereof.

A new method for incorporating fillers in a composite material is disclosed herein. The fillers are incorporated in the composite in the form of a sheet. These sheets comprise cellulose filaments, fillers and optionally reinforcing fibers. The formation of these sheets is allowed by the cellulose filaments which bind the fillers and optionally the reinforcing fibers together and creates, for example, a uniform distribution of all components within the sheet.

This new method may eliminate, for example, processing issues during infusion, and may allow, for example, for achieving higher filler loading and/or excellent filler distribution. The resulting laminate composites containing fillers may, for example, present good properties such as but not restricted to strength, stiffness, fire retardancy, wear and thermal expansion performance. The resulting laminate composites are suitable for example, for structural and non-structural composite materials, electric insulation or conductive materials, and overlays used in decorative laminates for any of the following sectors such as but not limited to mass transit, automotive or building applications.

In conventional liquid compression molding (LCM) composite manufacturing processes, fillers are mixed with resins using a high shear device prior to their injection. The addition of fillers generally causes an increase in viscosity of the resin which makes its injection and propagation though a reinforcing mat more difficult. These processing issues limit the quantity of fillers that can be added in the composite and tend to create defects in the resulting product. The methods of the present disclosure address these issues as fillers are already part of the cellulosic fiber-based sheet prior to resin impregnation. Mixing steps involving the resin and the fillers are eliminated, avoiding the risks of damaging the filler during high-shear dispersion of the filler within the resin matrix.

Further, fillers that are already in the form of a sheet may, for example, be permeable to the resin and therefore allow uniform and easy resin penetration. Therefore, fillers may, for example, no longer affect the resin viscosity during resin injection or infusion. An excellent filler distribution within the sheet may also eliminate, for example, issues related to the inhomogeneous dispersion of the filler which often occur during injection of the resin/filler mixture.

Consequently, the methods of the present disclosure may, for example, eliminate processing issues often encountered in liquid compression molding technologies such as resin transfer molding (RTM) as an example.

The present methods of filler incorporation in the form of a sheet within a laminate composite, also allowed the incorporation of a larger quantity of fillers within the final laminate composites of up to 60% by weight.

Because of their unfavorable geometrical features such as surface area and/or surface chemical composition, traditional fillers can moderately increase the modulus of the polymer, while strength properties such as tensile and flexion remain unchanged or even decrease. However, it has been shown that different physical forms of the same filler material can give markedly differing results at the same loading. (Rothon, R., Particulate-Filled Polymer Composites (2^{nd} edition)). In the composite materials of the present disclosure, cellulose filaments and fillers exhibit a configuration where both the fibrous elements and fillers are highly dispersed, oriented to different degrees and entangled. These features are useful, for example, in composite fabrication where high surface areas promote good resin impregnation and efficient stress transfer between the matrix, fiber and fillers. Accordingly, in addition to addressing resin viscosity issues and facilitating composite processing, the impregnation of fiber-reinforced highly loaded sheets with resin also provides useful mechanical properties over traditional composites prepared with a prior resin-mixing step.

Therefore according to an aspect of the present disclosure, there is provided a composite material comprising:
at least one sheet that comprises optionally about 5 to about 25% of cellulose filaments (CF), about 50 to about 95% of fillers, and about 0 to about 40% of reinforcing fibers, all of the percentages being expressed by weight, based on the total weight of the cellulose filaments, the fillers and the reinforcing fibers; and a resin.

According to another aspect of the present disclosure, there is provided a composite material comprising:
at least one sheet that comprises about 5 to about 25% of cellulose filaments (CF), about 50 to about 95% of fillers, and about 0 to about 40% of reinforcing fibers, all of the percentages being expressed by weight, based on the total weight of the cellulose filaments, the fillers and the reinforcing fibers; and a resin.

According to another aspect of the present disclosure, there is provided a composite material comprising:
at least one sheet that comprises 0 to about 25% of cellulose filaments (CF), about 50 to about 95% of fillers, and about 0 to about 40% of reinforcing fibers, all of the percentages being expressed by weight, based on the total weight of the cellulose filaments, the fillers and the reinforcing fibers; and a resin.

According to another aspect of the present disclosure, there is provided a composite material comprising:
at least one sheet that comprises, about 50 to about 95% of fillers, and about 0 to about 40% of reinforcing fibers, all of the percentages being expressed by weight, based on the total weight of the fillers and the reinforcing fibers; and a resin.

According to another aspect of the present disclosure, there is provided a composite material comprising:
at least one sheet that comprises optionally about 5 to about 25% of cellulose filaments (CF), about 50 to about 95% of fillers, and optionally reinforcing fibers, all of the percentages being expressed by weight, based on the total weight of the cellulose filaments, the fillers and the reinforcing fibers; and a resin.

According to another aspect of the present disclosure, there is provided a composite material comprising:
at least one sheet that comprises about 5 to about 25% of cellulose filaments (CF), about 50 to about 95% of fillers, and optionally reinforcing fibers, all of the percentages being expressed by weight, based on the total weight of the cellulose filaments, the fillers and the reinforcing fibers; and a resin.

According to another aspect of the present disclosure, there is provided a composite material comprising:
at least one sheet that comprises about 50 to about 95% of fillers, and optionally reinforcing fibers, all of the percentages being expressed by weight, based on the total weight of the fillers and the reinforcing fibers; and a resin.

According to another aspect of the present disclosure, there is provided a composite material comprising: at least one sheet that comprises 0 to about 25% of cellulose filaments (CF), about 50 to about 95% of fillers, and optionally reinforcing fibers, all of the percentages being expressed by weight, based on the total weight of the cellulose filaments, the fillers and the reinforcing fibers; and
a resin.

According to another aspect of the present disclosure, there is provided a method of preparing a composite material, the method comprising:
impregnating a plurality of the at least one sheet of the present disclosure with resin to obtain a plurality of resin-impregnated sheets;
stacking the plurality of resin-impregnated sheets; and
curing the resin under conditions to obtain the composite material.

According to another aspect of the present disclosure, there is provided a method of preparing a composite material, the method comprising:
impregnating a plurality of the at least one sheet of the present disclosure with resin to obtain a plurality of resin-impregnated sheets;
impregnating a plurality of the at least one other sheet of the present disclosure to obtain a plurality of resin-impregnated other sheets;
stacking the plurality of resin-impregnated sheets alternatingly with the plurality of resin-impregnated other sheets; and
curing the resin under conditions to obtain the composite material.

According to another aspect of the present disclosure, there is provided a method for preparing a composite material, the method comprising:
stacking a plurality of the at least one sheet of the present disclosure to form a stack of sheets;
impregnating the stack of sheets with resin; and
curing the resin under conditions to obtain the composite material.

According to another aspect of the present disclosure, there is provided a method of preparing a composite material, the method comprising:
stacking a plurality of the at least one sheet of the present disclosure alternatingly with a plurality of the at least one other sheet of the present disclosure to form a stack of sheets;
impregnating the stack of sheets with resin; and
curing the resin under conditions to obtain the composite material.

According to another aspect of the present disclosure, there is provided a method of preparing a composite material, the method comprising:
impregnating a panel with resin to obtain a resin-impregnated panel; and
curing the resin under conditions to obtain the composite material.

According to another aspect of the present disclosure, there is provided a method of preparing a composite material, the method comprising:
impregnating a preform with resin to obtain a resin-impregnated preform; and
curing the resin under conditions to obtain the composite material.

The present disclosure relates to composite materials and methods for the preparation thereof. For example, the present disclosure relates to composite materials that can comprise higher filler loading up to 60% by weight with a uniform filler distribution on the final composite. This method would at least partially address one of the composite processing issues concerning filler incorporation in composites providing an alternative method to the known composite materials and/or methods of preparation thereof.

For example, the present disclosure relates to composite materials comprising a resin, fillers, cellulose filaments (CF) and reinforcing fibres chosen from but not limited to wood pulp, fiberglass, carbon, aramid, natural fibers and mixtures thereof. The present disclosure relates to the filler incorporation in composites in the form of a sheet, panel or preform.

The fillers, cellulose filaments (CF) and reinforcing fibres can be mixed together in an aqueous suspension and by following a papermaking process they can be provided in sheet form when the sheet has a basis weight lower than 300 g/m², in panel form when the sheet has a basis weight higher than 300 g/m² and within a 2D geometry and in preform form when the panel has any 3D geometry.

For example, for the filler incorporation method under sheet form, the formation of these sheets characterized by an appropriate strength can be possible through the high potential binding of the cellulose filaments (CF) which are able to bind the fillers and the reinforcing fibres together and create, for example, a uniform distribution of all components within the sheet.

For example, for the filler incorporation method in a panel or preform, the formation of these panels or preforms characterized by an appropriate strength can be possible with and without cellulose filaments (CF) according to the described examples on the present disclosure. The lower potential binding of the reinforcing fibres can be sufficient to bind the fillers and the reinforcing fibres together and create, for example, a uniform distribution of all components within the panel or preform.

For example, the filler incorporation in composites within cellulose filaments (CF) and reinforcing fibres under the three forms (sheet, panel and preform) can allow for higher filler loading up to 60% by weight in the final composites with a uniform filler distribution and allows for good resin impregnation without any dry or unevenly impregnated spots in the final composite.

### BRIEF DESCRIPTION OF THE DRAWINGS

In the following drawings, which represent by way of example only, various embodiments of the disclosure :

FIG. 1 is a schematic of a method of preparing composite materials according to examples of the present disclosure comprising hand lay-up, intercalation and compression molding processes.

FIG. 2 shows plots of flexural (left hand side of plot) and tensile (right hand side of plot) moduli, in the machine direction (MD), of resin/gypsum composites prepared using two modes of gypsum incorporation; gypsum crystals mixed with resin (Resin+gypsum) and a network consisting of oriented cellulose filaments (CF) and compacted gypsum that is impregnated by resin (Composite resin/CF/gypsum) according to an example of the present disclosure. The plots also show flexural and tensile moduli for resin alone (Resin).

FIG. 3 shows plots of flexural (left hand side of plot) and tensile (right hand side of plot) stresses, in the machine direction (MD), of resin/gypsum composites prepared using two modes of gypsum incorporation; gypsum crystals mixed with resin (Resin+gypsum) and a network consisting of oriented cellulose filaments (CF) and compacted gypsum that is impregnated by resin (Composite resin/CF/gypsum) according to an example of the present disclosure. The plots also show flexural and tensile moduli for resin alone (Resin).

FIG. 4 is a plot showing a comparison of the tensile modulus, in the machine direction (MD), of epoxy laminate composites according to examples of the present disclosure having 30% resin and made with various sheet compositions (from left to right: 100% Northern Bleached Softwood Kraft (NBSK); 36% NBSK, 4% CF and 30% gypsum; 24.5% NBSK, 5.5% CF and 40% gypsum; 13% NBSK, 7% CF and 50% gypsum; 15% CF and 55% gypsum; 9% CF and 61% gypsum).

FIGS. 5A and 5B shows plots providing a comparison of FIG. 5A tensile stress and FIG. 5BB flexural stress of two epoxy composites according to examples of the present disclosure, one having 5.5% cellulose filaments (CF), 11.5% Northern Bleached Softwood Kraft (NBSK), 35% gypsum and 48% resin (left hand side of both plots) and the other having 6% CF, 8.5% NBSK, 36.7% gypsum and 48.8% resin (right hand side of both plots) and made by either laminating several sheets of a single sheet containing the three elements NBSK, CF and gypsum (right hand side of both plots) or by intercalating two kinds of sheets, namely CF/gypsum sheets and NBSK sheets (left hand side of both plots).

FIGS. 6A and 6B show plots providing a comparison between panel composites and laminates composites and more particularly regarding tensile and flexural stresses (see FIG. 6A) and tensile and flexural moduli (see FIG. 6B), wherein panel and laminate composites comprise resin-impregnated cellulose filaments (CF), NBSK and ATH.

FIGS. 7A and 7B show plots providing a comparison between panel composites comprising cellulose filaments and panel composites that do not comprise cellulose filaments and more particularly regarding tensile and flexural stresses (see FIG. 7A) and tensile and flexural moduli (see FIG. 7B), wherein the panel composites comprise resin-impregnated NBSK and ATH, and optionally cellulose filaments (CF).

### DETAILED DESCRIPTION

I. Definitions

Unless otherwise indicated, the definitions and embodiments described in this and other sections are intended to be applicable to all embodiments and aspects of the present disclosure herein described for which they are suitable as would be understood by a person skilled in the art.

As used in the present disclosure, the singular forms “a”, “an” and “the” include plural references unless the content clearly dictates otherwise. For example, an embodiment including “a resin” should be understood to present certain aspects with one resin, or two or more additional resins.

In embodiments comprising an “additional” or “second” component, such as an additional or second resin, the second component as used herein is different from the other components or first component. A “third” component is different from the other, first, and second components, and further enumerated or “additional” components are similarly different.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “about” and “approximately” as used herein mean a reasonable amount of deviation of the modified term such that the end result is not significantly changed. These terms of degree should be construed as including a deviation of at least±5% or at least±10% of the modified term if this deviation would not negate the meaning of the word it modifies.

The terms “cellulose filaments” or “CF” and the like as used herein refer to filaments obtained from cellulose fibers having a high aspect ratio, for example, an average aspect ratio of at least about 200, for example, an average aspect ratio of from about 200 to about 5000, an average width in the nanometer range, for example, an average width of from about 30 nm to about 500 nm and an average length in the micrometer range or above, for example, an average length above about 10 μm, for example an average length of from about 200 μm to about 2 mm. Such cellulose filaments can be obtained, for example, from a process which uses mechanical means only, for example, the methods disclosed in US Patent Application Publication No. 2013/0017394 filed on Jan. 19, 2012. For example, such method produces cellulose filaments that can be free of chemical additives and free of derivatization using, for example, a conventional high consistency refiner operated at solid concentrations (or consistencies) of at least about 20 wt %. These strong cellulose filaments are, for example, under proper mixing conditions, re-dispersible in water or aqueous slurries such as aqueous slurries of fillers . For example, the cellulose fibers from which the cellulose filaments are obtained can be but are not limited to Kraft fibers such as Northern Bleached Softwood Kraft (NBSK), but other kinds of suitable fiber are also applicable, the selection of which can be made by a person skilled in the art.

The term “sheet” as used herein includes a mat.

For example, the sheet can be in the form of a panel or a preform.

For example, the panel or preform can have a 3D geometry.

The term “fillers” as used herein includes a single type of filler as well as including a combination of different fillers.

The term “fibers” as used herein includes a single type of fibers as well as including a combination of different fibers.

The term “reinforcing fibers” as used herein includes a single type of reinforcing fibers as well as including a combination of different reinforcing fibers.

II. Composite Materials

For example, the composite material can be a laminate.

For example, the composite material can be a panel or a preform.

For example, the panel or preform can have a 3D geometry.

For example, the at least one sheet can be impregnated with the resin.

The sheet can comprise any suitable amount of cellulose filaments from about 5% to about 25% by weight, based on the total weight of the cellulose filaments, the fillers and the reinforcing fibers. For example, the sheet can comprise at least about 6%, about 10%, about 15% or about 20% of cellulose filaments by weight (i.e. up to a maximum of about 25% of cellulose filaments by weight), based on the total weight of the cellulose filaments, the fillers and the reinforcing fibers. For example, the sheet can comprise about 12% to about 25%, about 5% to about 15%, about 5% to about 20%, about 8% to about 25% or about 8% to about 20% of cellulose filaments by weight, based on the total weight of the cellulose filaments, the fillers and the reinforcing fibers.

The sheet can comprise any suitable amount of fillers from about 50% to about 95% by weight, based on the total weight of the cellulose filaments, the fillers and the reinforcing fibers. For example, the sheet can comprise at least about 55%, about 60%, about 70%, about 80%, about 90% or about 92% of fillers by weight (i.e. up to a maximum of about 95% of fillers by weight), based on the total weight of the cellulose filaments, the fillers and the reinforcing fibers. For example, the sheet can comprise about 58% to about 95%, about 65% to about 90%, about 80% to about 92% or about 70% to about 85% of fillers by weight, based on the total weight of the cellulose filaments, the fillers and the reinforcing fibers.

The sheet can comprise either none or any suitable amount of reinforcing fibers up to about 40% by weight, based on the total weight of the cellulose filaments, the fillers and the reinforcing fibers. For example, the sheet can comprise about 1% to about 40%, about 1% to about 35%, about 5% to about 40%, about 7% to about 30%, about 10% to about 25% or about 15% to about 20% of reinforcing fibers by weight, based on the total weight of the cellulose filaments, the fillers and the reinforcing fibers.

The reinforcing fibers can be any suitable reinforcing fibers. For example, the reinforcing fibers can be chosen from but not restricted to wood fibers, natural fibers, glass fibers, aramid fibers, carbon fibers and mixtures thereof. For example, the reinforcing fibers can be a cellulose-based fiber. For example, the cellulose-based fiber can be Kraft fibers. For example the Kraft fibers can be Northern Bleached Softwood Kraft (NBSK) fibers. For example, the natural fibers can be hemp, flax, jute or mixtures thereof.

For example, the sheet can comprise about 10% to about 15% of the cellulose filaments, about 70% to about 80% of the fillers and about 15% to about 25% of the reinforcing fibers, based on the total weight of the cellulose filaments, the fillers and the reinforcing fibers.

The cellulose filaments can be any suitable cellulose filaments. For example, the cellulose filaments can be produced by a method disclosed in PCT Application Publication No. 2012/097446 A1 (High Aspect Ratio Cellulose Nanofilaments and Method for their Production) to Hua, X. et al. For example, the cellulose filaments can have an average length of from about 200 μm to about 2 mm. For example, the cellulose filaments can have an average width of from about 30 nm to about 500 nm. For example, the cellulose filaments can have an average aspect ratio of from about 200 to about 5000.

The fillers can be any suitable fillers. A person skilled in the art can readily select suitable fillers to impart specific attributes to the composite material. For example, the fillers can be organic fillers. For example, the fillers can be inorganic fillers. For example, the fillers can be chosen from calcium sulfate, clay, calcium carbonate, alumina trihydrate (ATH), magnesium hydroxide (MDH), hollow glass microspheres, exfoliated graphite nano-platelets and mixtures thereof. For example, the fillers can comprise CaSO₄.2H₂O, CaSO₄.1/2H₂O or mixtures thereof. For example, the fillers can consist essentially of CaSO₄.2H₂O, CaSO₄.1/2H₂O or mixtures thereof. For example, the fillers can consist of CaSO₄.2H₂O, CaSO₄.1/2H₂O or mixtures thereof. For example, to obtain sheets comprising, consisting essentially of or consisting of CaSO₄.1/2H₂O, sheets comprising, consisting essentially of or consisting of CaSO₄.2H₂O can be dried for a suitable time at a suitable temperature to obtain the sheets comprising, consisting essentially of or consisting of CaSO₄.1/2H₂O. For example, the sheets can be dried at about 150° C. for about 4 hours.

The sheet can be prepared by any suitable means. For example, the sheet can be prepared by a method comprising:
preparing a dry mat comprising a mixture of the optional cellulose filaments, the fillers and optionally the reinforcing fibers.

The dry mat can be any suitable dry mat. For example, the dry mat can be a sheet as disclosed in U.S. patent application Ser. No. 14/876,244 (Compositions, panels and sheets comprising mineral fillers and methods to produce the same) and/or prepared by a method disclosed therein. For example, the dry mat can have a basis weight of about 60 g/m² to about 240 g/m², about 100 g/m² to about 300 g/m², about 150 g/m² to about 300 g/m², about 300 g/m² to about 2000 g/m², about 1500 g/m² to about 4000 g/m² or about 3000 g/m² to about 4000 g/m².

For example, the dry mat can be prepared by a wet laid process such as a papermaking process.

For example, the dry mat can be prepared by a method comprising:
filtering an aqueous suspension comprising the optional cellulose filaments, the fillers and optionally the reinforcing fibers under conditions to obtain a wet pad; and
drying the wet pad under conditions to obtain the dry mat.

For example, the dry mat can be prepared by a method comprising:
draining an aqueous suspension comprising the optional cellulose filaments, the fillers and optionally the reinforcing fibers under conditions to obtain a wet fiber mat;
pressing the wet fiber mat under conditions to remove water and obtain a pressed mat; and
drying the pressed mat under conditions to obtain the dry mat.

For example, the sheet has a 3D geometry and is prepared by a method comprising:
preparing a dry mat comprising a mixture of the optional cellulose filaments, the fillers and the reinforcing fibers,
wherein the dry mat is prepared by :
spraying an aqueous suspension comprising the optional cellulose filaments, the fillers and the reinforcing fibers through a perforated 3D mold mounted on a rotatory base and connected to vacuum system for filtration or drainage to obtain a wet pad; and
drying the wet pad under conditions to obtain the dry mat

For example, the sheet has a 3D geometry and is prepared by a method comprising:
preparing a dry mat comprising a mixture of the optional cellulose filaments, the fillers and the reinforcing fibers,
wherein the dry mat is prepared by:
spraying an aqueous suspension comprising the optional cellulose filaments, the fillers and the reinforcing fibers through a perforated 3D mold mounted on a rotatory base and connected to vacuum system for filtration or drainage to obtain a wet pad;
pressing the wet pad under conditions to remove water and obtain a pressed mat; and
drying the pressed mat under conditions to obtain the dry mat.

For example, the composite material can be a laminate material comprising a plurality of the sheets. For example, the composite can be in the form of a panel or a preform. For example, the panel or preform can have a 3D geometry.

The composite material can comprise any suitable amount of resin. For example, the composite material can comprise about 20% to about 70%, about 20% to about 55%, about 30% to about 60%, about 30% to about 40%, about 30% to about 35%, about 40% to about 60% or about 50% resin by weight, based on the total weight of the composite material.

The resin can be any suitable resin. A person skilled in the art can readily select the resin based, for example, on the intended end use of the finished composite material. For example, the resin can be a liquid thermoplastic resin, for example, to produce composite materials by thermoforming. For example, the resin can be a thermosetting resin. For example, the thermosetting resin can be chosen from an epoxy resin, a phenol formaldehyde resin, an unsaturated polyester resin without styrene, an unsaturated polyester resin with styrene, a vinyl ester resin, a water-based polyacrylic resin and mixtures thereof. For example, the thermosetting resin can be a low viscosity epoxy resin. For example, the low viscosity epoxy resin can be a multifunctional resin comprising epoxide groups and reactive unsaturation (e.g. EPON™8021).

Optionally, the resin is cured in the presence of a curing agent. The curing agent can be any suitable curing agent. For example, the resin can be an epoxy resin and the curing agent can be an aliphatic amine curing agent (e.g. EPIKURE™3234). For example, the ratio of the resin to the curing agent can be from about 100:20 to about 100:12. For example, the ratio of the resin to the curing agent can be from about 100:17 to about 100:15.

For example, the composite material can have a flexural modulus that is greater than the flexural modulus of a composite prepared by a method comprising mixing a corresponding amount of fillers and resin. For example, the composite material can have a flexural modulus of at least 6, 7, 8, 9 or 10 GPa when measured according to ASTM D790.

For example, the composite material can have a tensile modulus that is greater than the tensile modulus of a composite prepared by a method comprising mixing a corresponding amount of fillers and resin. For example, the composite material can have a tensile modulus of at least 300, 500, 800, 1000 or 1100 MPa when measured according to ASTM D638.

For example, the composite material can have a flexural stress that is greater than the flexural stress of a composite prepared by a method comprising mixing a corresponding amount of fillers and resin. For example, the composite material can have a flexural stress of at least 50, 60, 70, 80, 90, 100 or 110 MPa when measured according to ASTM D790.

For example, the composite material can have a tensile stress that is greater than the tensile stress of a composite prepared by a method comprising mixing a corresponding amount of fillers and resin. For example, the composite material can have a tensile stress of at least 20, 30, 40, 50 or 60 MPa when measured according to ASTM D638.

For example, the composite material can further comprise at least one other sheet, that is different from at least one sheet, and wherein the at least one other sheet comprises fibers chosen from but not limited to wood pulp, fiberglass, aramid, carbon, natural fibers, and mixtures thereof. For example, the natural fibers can be hemp, flax, jute or mixtures thereof. For example, the at least one other sheet can comprise cellulose-based fibers. The cellulose-based fibers can be any suitable cellulose-based fibers. For example, the cellulose-based fibers can be Kraft fibers. For example, the Kraft fibers can be Northern Bleached Softwood Kraft (NBSK) fibers. For example, the composite material can comprise a plurality of the at least one sheet of the present disclosure and a plurality of the at least one other sheet of the present disclosure, the sheets being stacked alternatingly by alternating the at least one sheet and the at least one other sheet.

For example, the composite material comprising the alternating sheets can have a tensile modulus that is greater than the tensile modulus of a composite material with a corresponding amount of resin but comprising sheets without reinforcing fibers. For example, the composite material can have a tensile modulus of at least 4, 5 or 6 GPa when measured according to ASTM D638.

For example, the sheets in the plurality of the at least one sheet may not comprise reinforcing fibers and the composite material can have a tensile stress that is similar to the tensile stress of a corresponding composite material without the plurality of the at least one other sheet but which comprises a plurality of sheets comprising reinforcing fibers. For example, the sheets in the plurality of the at least one sheet may not comprise reinforcing fibers and the composite material can have a flexural stress that is similar to the flexural stress of a corresponding composite material without the plurality of the at least one other sheet but which comprises a plurality of sheets comprising reinforcing fibers.

The composite material can be applied in any suitable use. For example, the composite material can be one of a structural composite, a non-structural composite, an electrically insulating material, an electrically conductive material, a wall, a decorative overlay, a wear-resistant overlay, a building panel, a floor, a skin, a part for mass transit or a part for the automotive industry.

III. Methods of Preparation

The present disclosure includes a method of preparing a composite material, the method comprising:
impregnating a plurality of the at least one sheet of the present disclosure with resin to obtain a plurality of resin-impregnated sheets;
stacking the plurality of resin-impregnated sheets; and
curing the resin under conditions to obtain the composite material.

The present disclosure also includes a method of preparing a composite material, the method comprising:
impregnating a plurality of the at least one sheet of the present disclosure with resin to obtain a plurality of resin-impregnated sheets;
impregnating a plurality of the at least one other sheet of the present disclosure to obtain a plurality of resin-impregnated other sheets;
stacking the plurality of resin-impregnated sheets alternatingly with the plurality of resin-impregnated other sheets; and
curing the resin under conditions to obtain the composite material.

The present disclosure also includes a method of preparing a composite material, the method comprising:
stacking a plurality of the at least one sheet of the present disclosure to form a stack of sheets;
impregnating the stack of sheets with resin; and
curing the resin under conditions to obtain the composite material.

The present disclosure also includes a method of preparing a composite material, the method comprising:
stacking a plurality of the at least one sheet of the present disclosure alternatingly with a plurality of the at least one other sheet of the present disclosure to form a stack of sheets;
impregnating the stack of sheets with resin; and
curing the resin under conditions to obtain the composite material.

The methods for impregnating a sheet, a plurality of sheets or the stack of sheets and curing can be any suitable methods, the selection of which can be made by a person skilled in the art. For example, methods used to produce the composite materials can comprise a hand lay-up process, a B-stage pre-preg process, vacuum infusion, vacuum assisted resin transfer molding (VARTM), thermoforming, resin transfer molding (RTM), and compression molding. For example, when the methods comprise impregnating then stacking then curing, the methods can comprise a hand lay-up process, thermoforming or a B-stage pre-preg process. For example, when the methods comprise stacking then impregnating then curing, the methods can comprise vacuum infusion, vacuum-assisted resin transfer molding (VARTM), resin transfer molding (RTM) or compression molding. For example, the resin can comprise a thermosetting resin that is impregnated in a method comprising a hand lay-up process. For example, the conditions to obtain the composite material can comprise curing the resin while compressing the impregnated stacked sheets at a pressure, time and temperature suitable to obtain the composite material.

The person skilled in the art would understand that similar techniques can be applied when impregnating a single sheet, a panel or a preform.

For example, wherein impregnating the panel or the preform and curing can be carried out by vacuum infusion, vacuum assisted resin transfer molding (VARTM), thermoforming, resin transfer molding (RTM), compression molding or a B-stage pre-preg process.

For example, the sheets can be stacked so that each sheet has the same fiber orientation. For example, the fiber orientation can be in the machine direction.

It will be appreciated by a person skilled in the art that embodiments relating to the composite materials (such as for the sheets and resin) and the methods of the present disclosure can be varied as detailed herein for the embodiments of the composite materials of the present disclosure.

The below presented examples are non-limitative and are used to better exemplify the processes of the present disclosure.

### EXAMPLES

General Materials and Methods

Percentages are by weight based on dry weight.

Flexural modulus and stress were tested using ASTM D790 and tensile modulus and stress were tested using ASTM D638.

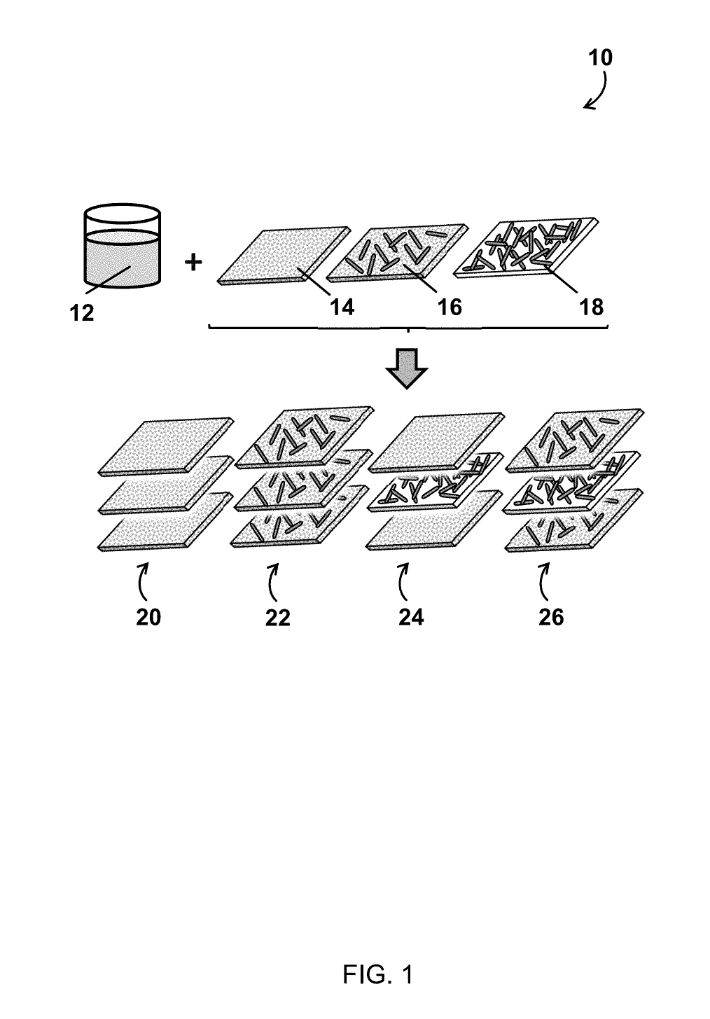

FIG. 1 shows a schematic of a method 10 of preparing composite materials according to examples of the present disclosure. Referring to FIG. 1, resin (12) impregnates sheets comprising cellulose filaments and fillers (14) or sheets comprising cellulose filaments, fillers and reinforcing fibers (16) and optionally into sheets comprising fibers (18). The impregnated sheets are stacked as shown in the schematic to obtain composite materials comprising a plurality of sheets comprising cellulose filaments and fillers (20), composite materials comprising a plurality of sheets comprising cellulose filaments, fillers and reinforcing fibers (22); composite materials comprising a plurality of sheets comprising cellulose filaments and fillers alternating with a plurality of other sheets comprising fibers (24); and composite materials comprising a plurality of sheets comprising cellulose filaments, fillers and reinforcing fibers alternating with a plurality of other sheets comprising fibers (26). The stacked sheets were cured under conditions (336 psi, 10 min, 150° C.) to cure the resin and obtain the desired composite material.

### Example 1

### Laminate Comprising Resin-Impregnated CF-Gypsum

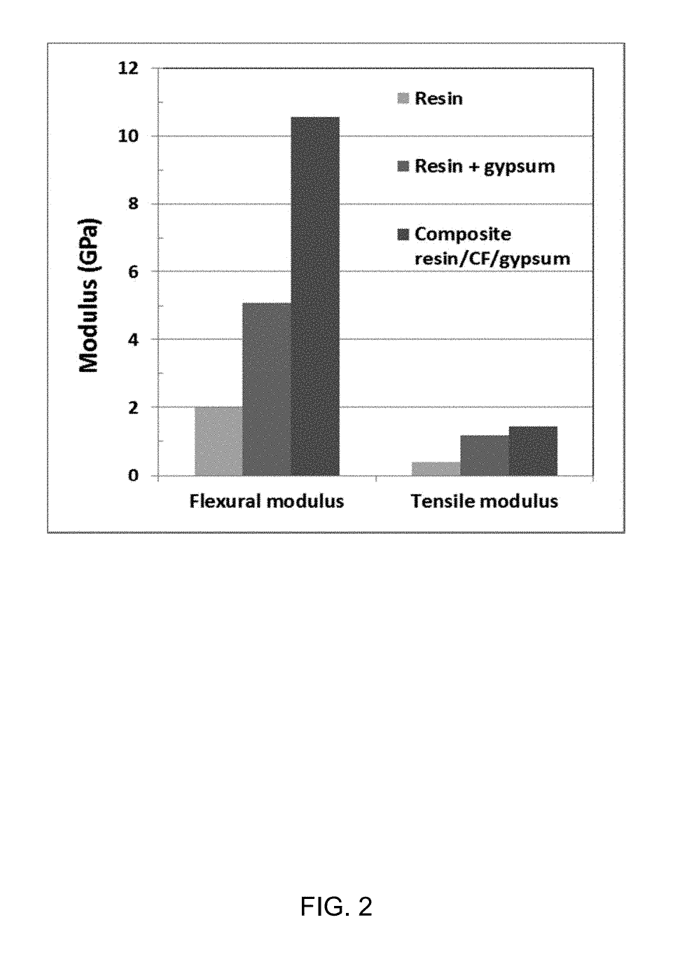

A laminate having 15-17 sheets and a thickness of about 3 mm made of impregnated (resin impregnated using a hand lay-up process) and cured cellulose filament (CF)-gypsum sheets (90% gypsum; 10% CF prior to impregnation with the resin) was found to have superior mechanical performance when compared to a composite prepared from the resin alone mixed with a corresponding amount of gypsum (FIG. 2). The resin was a low viscosity epoxy resin (EPON™8021) mixed with the hardener (curing agent EPIKURE™3234) at a ratio of 100 parts resin/16 parts hardener. The ratios used were as follows:
Resin+gypsum: 40% resin, 60% gypsum
Composite-Resin/CF/gypsum: 40% resin, 54% gypsum, 6% CF

The addition of filler to resin increases the modulus in comparison to a sample of resin alone, as can be observed in FIG. 2 for the Resin+gypsum sample. However, when gypsum is incorporated in the form of a sheet, held together by a minimal amount of CF, the modulus increases significantly. While not wishing to be limited by theory, this can be explained by the orientation of crystals and high particle packing and dispersion, which favor percolation and which is directly related to the rigidity of the material.

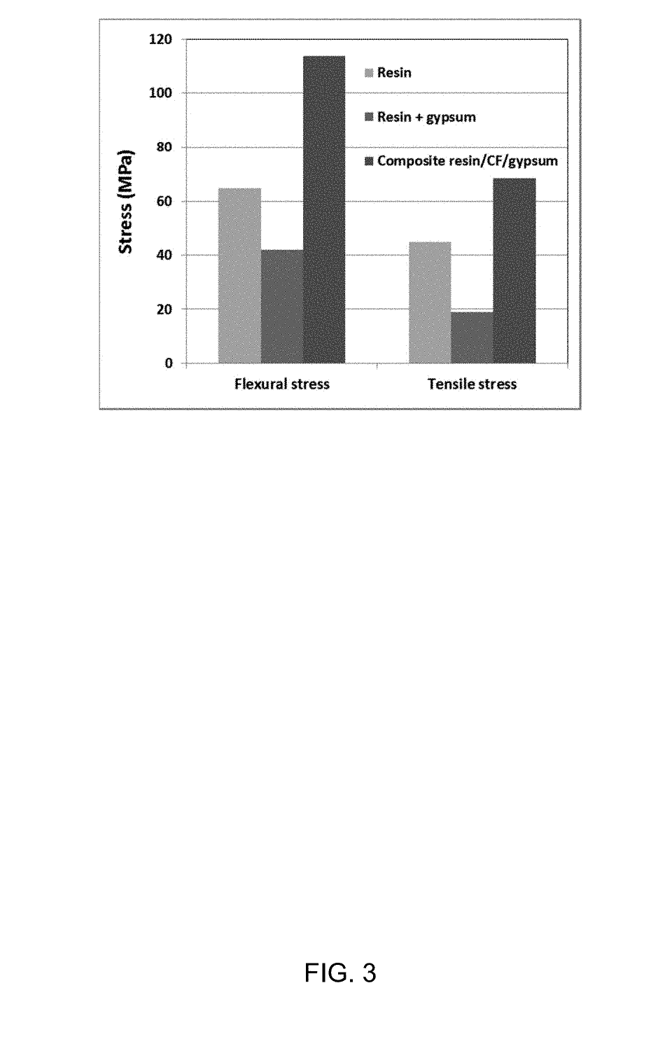

As can be seen from FIG. 3, the addition of gypsum is detrimental to the resin flexural and tensile strength. However, when gypsum is in the form of a sheet that is reinforced with CF, it provides greater flexural and tensile stress as compared to the pure resin or the resin filled with gypsum. These results clearly demonstrate the usefulness of using gypsum reinforced with CF in the form of a pre-formed sheet that is then impregnated with resin.

In this example, calcium sulfate mineral filler was used. However, any other filler which possesses a suitable geometry for binding efficiently to cellulose filaments can be selected to impart desired properties to the composite. For example, the filler can be chosen from calcium sulfate, clay, calcium carbonate, alumina trihydrate (ATH), magnesium hydroxide (MDH), hollow glass microspheres, exfoliated graphite nano-platelets, mixtures thereof and any other suitable inorganic or organic filler that can, for example, impart specific attributes to composite materials such as but not limited to attributes such as impact strength, compression strength and/or flame retardancy.

The resin used in this example, was an epoxy resin. However, the resin used to produce the laminate may be of any desired type and its selection will be governed, for example, by the intended end use of the finished composite. For example, epoxy, phenol formaldehyde, unsaturated polyesters with and without styrene, vinyl ester and/or water-based polyacrylic resins may be used.

### Example 2

### Laminates Comprising Intercalated Sheets and Other Fibers

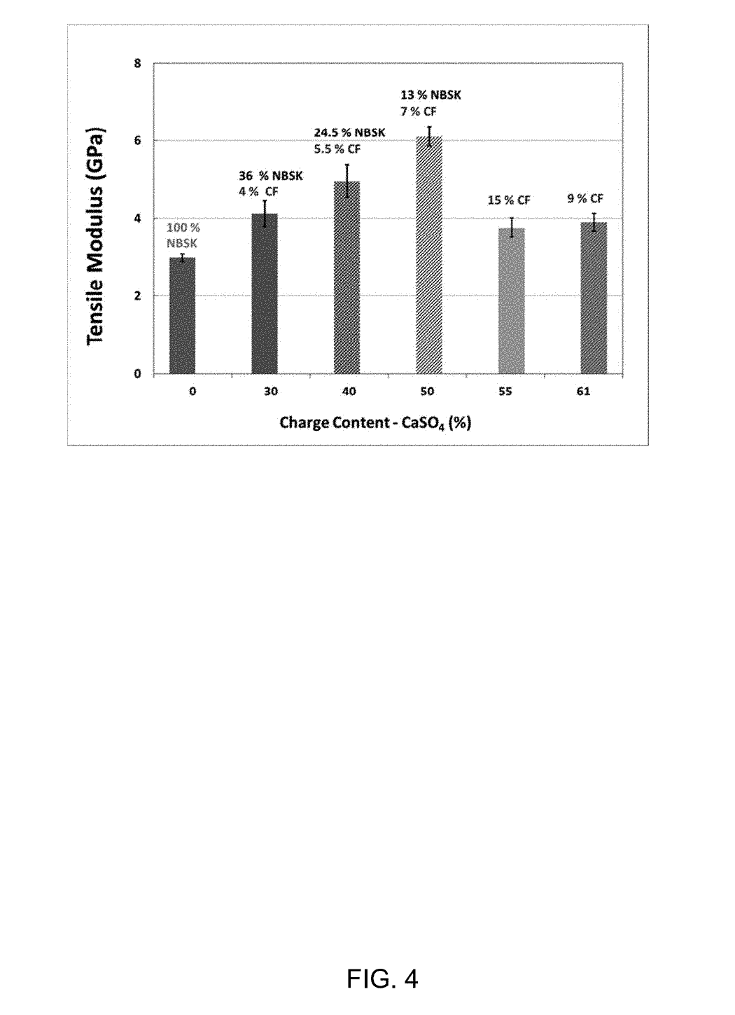

In FIG. 4, laminate composites without fillers were made from 8 to 10 intercalated Northern Bleached Softwood Kraft (NBSK) sheets. Highly loaded-gypsum fiber-based laminate composites corresponding to gypsum (CaSO₄) contents respectively of 30%, 40% and 50% were made by intercalation of a specific number of CF-gypsum and NBSK (CF-Gypsum/NBSK) sheets 13/2 (30%), 11/4 (40%) and 8/5 (30%). The laminate composites corresponding to 55% and 61% gypsum content were made from 15 to 17 intercalated CF-gypsum sheets alone. The thickness of the laminates was about 3 mm.

For all the laminate composites produced, the corresponding sheets were impregnated with epoxy resin first by a hand lay-up process, stacked together with the same fiber orientation (in the machine direction (MD)) and compressed and cured at a given pressure, time and temperature (336 psi, 10 min, 150° C.).

CF-gypsum sheets can be used alone or in combination with other fiber mats, which include but are not limited to cellulosic fibers, carbon fibers and glass fibers. For example, in FIG. 4, the intercalation of CF-gypsum sheets with NBSK sheets produces a synergistic effect where the resulting composites have superior tensile moduli than that of their individual components. Although not shown herein, these improvements were possible without significantly affecting strength properties which usually occurs when mineral fillers are incorporated into composites. Similar results were also obtained in flexion.

Cellulose filaments (CF), fillers and fibres such as wood, natural (e.g. hemp, flax and/or jute), glass and/or carbon fibres, can also be incorporated in a single sheet to produce, for example, a multilayer performance composite laminate.

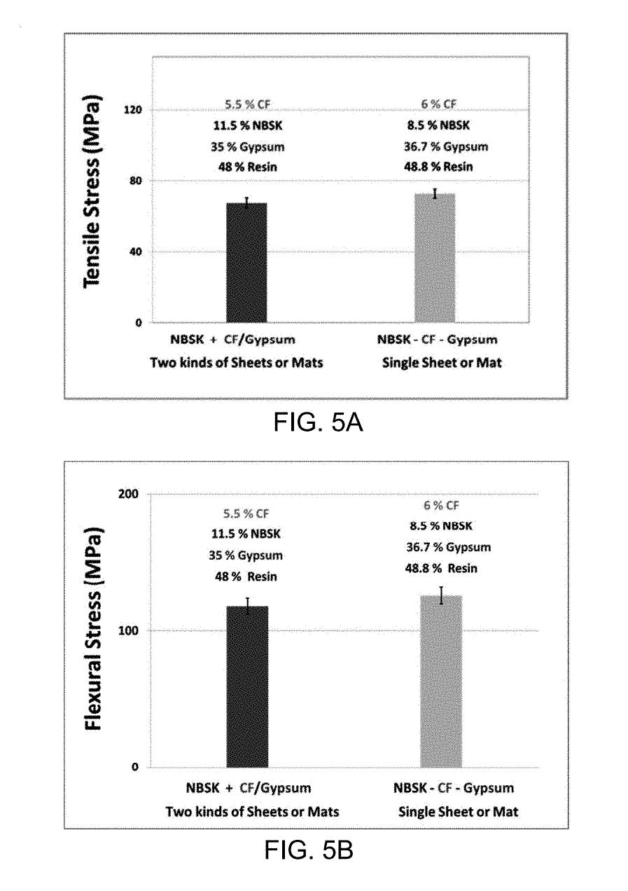

For example, a composite laminate made from the stacking of sheets, each containing an identical mixture of CF, gypsum and Kraft fibers was prepared. This composite laminate was found to have mechanical properties that were similar to those of an intercalated laminate made of CF-Gypsum sheets and Kraft sheets and having a similar composition of fillers, fibers and resin. Comparisons between these two types of composites are shown in FIG. 5.

The hand lay-up method was used in the present example. Other suitable processing methods used to produce such laminates can include, for example, B-stage pre-preg process, vacuum infusion, vacuum assisted resin transfer molding (VARTM), thermoforming, resin transfer molding (RTM), and compression molding.

Applications may include, for example, wear-resistant overlays, bulk molding compound, sheet molding compound and other types of laminates for, example, for building, construction, sporting goods and mass transit applications.

### Example 3

### Laminate and Panel Composites Comprising Resin-Impregnated CF/NBSK/Alumina Trihydrate (ATH)

Percentages are by weight based on dry weight. Flexural modulus and stress were tested using ASTM D790 and tensile modulus and stress were tested using ASTM D638.

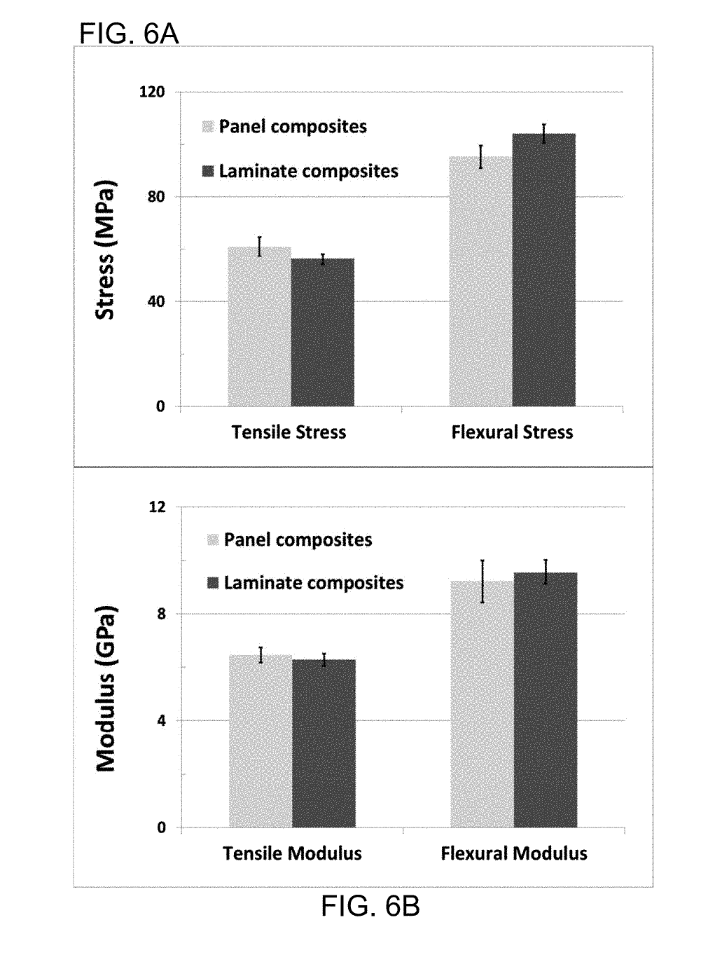

A laminate having 12 sheets (2400 g/m²) and a thickness of about 3 mm made of impregnated (resin impregnated using a hand lay-up process) and cured cellulose filament CF/NBSK/ATH sheets (13% CF; 17% NBSK and 70% ATH prior to impregnation with the resin) was found to have similar mechanical performance when compared to a composite having one panel (corresponds to one high basis weight sheet at 2400 g/m²) made of impregnated (resin impregnated using infusion process) and cured cellulose filament CF/NBSK/ATH panel (13% CF; 17% NBSK and 70% ATH prior to impregnation with the resin) (FIG. 6A). The resin was a low viscosity polyester resin (RL2710) mixed with the hardener (curing agent MEKP925) at a ratio of 100 parts resin/1.25 parts hardener. The ratios used were as follows:
Laminate-Resin/CF/NBSK/ATH 40% resin, 7.8% CF, 10.2% NBSK, 42% ATH
Composite-Resin/CF/NBSK/ATH 40% resin, 7.8% CF, 10.2% NBSK, 42% ATH

As can be seen from FIGS. 6A and 6B, the laminate made by stacking a plurality of twelve impregnated sheets comprising cellulose filament (CF), NBSK and ATH exhibit similar tensile, flexural stresses and moduli compared to a composite made from a impregnated panel comprising cellulose filaments (CF), NBSK and ATH at similar proportions.

### Example 4

### Panel Composites Comprising Resin-Impregnated NBSK and ATH with and Without Cellulose Filaments (CF)

Percentages are by weight based on dry weight. Flexural modulus and stress were tested using ASTM D790 and tensile modulus and stress were tested using ASTM D638.

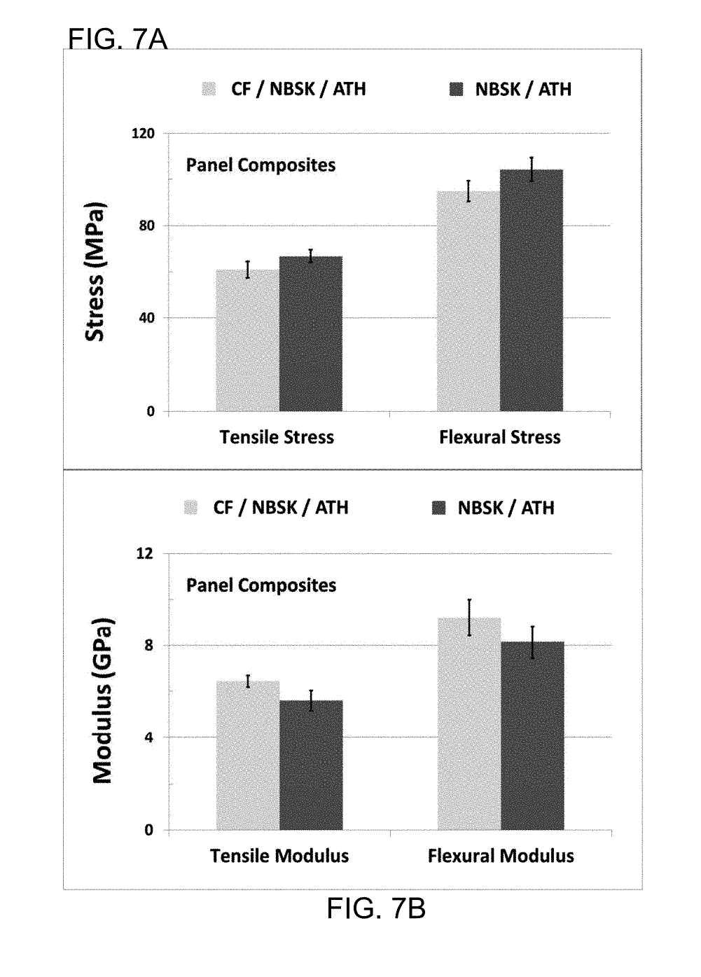

As it can be seen from FIGS. 7A and 7B composite having one panel (corresponds to one high basis weight sheet at 2400 g/m²) within cellulose filaments (CF) made of impregnated (resin impregnated using infusion process) and cured cellulose filament CF/NBSK/ATH panel (13% CF; 17% NBSK and 70% ATH prior to impregnation with the resin) was found to have similar mechanical performance when compared to a composite having one panel (corresponds to one high basis weight sheet at 2400 g/m²) without cellulose filaments (CF) made of impregnated (resin impregnated using infusion process) and cured NBSK/ATH panel (30% NBSK and 70% ATH prior to impregnation with the resin). The resin was a low viscosity polyester resin (RL2710) mixed with the hardener (curing agent MEKP925) at a ratio of 100 parts resin/1.25 of hardener. The ratios used were as follows:
Composite-Resin/CF/NBSK/ATH 40% resin, 7.8% CF, 10.2% NBSK, 42% ATH
Composite-Resin/NBSK/ATH 40% resin, 18% NBSK, 42% ATH

As can be seen from FIGS. 7A and 7B, the composite made by impregnating one panel comprising NBSK and ATH within cellulose filaments (CF), presents similar tensile, flexural stresses and moduli compared to a composite made from an impregnated panel comprising NBSK and ATH without cellulose filaments (CF).

These results show that composites based on panels comprising fillers and reinforcing fibres within and without without cellulose filaments (CF) present similar performances proving that both panels are characterized by an appropriate strength to reinforce composites. The lower potential binding of the reinforcing fibres is sufficient to bind the fillers and the reinforcing fibres together and create, for example, a uniform distribution of all components within the panel or preform.

While a description was made with particular reference to the specific embodiments, it will be understood that numerous modifications thereto will appear to those skilled in the art. Accordingly, the above description and accompanying drawings should be taken as specific examples and not in a limiting sense.

What is claimed is:

1. A composite material comprising:
at least one sheet that comprises about 50 to about 95% of fillers, and about 0 to about 40% of reinforcing fibers, all of said percentages being expressed by weight, based on the total weight of the fillers and the reinforcing fibers; and
a resin.

2. The composite material of claim 1, wherein said at least one sheet is impregnated with said resin.

3. The composite material of claim 1, wherein the sheet further comprises cellulose filaments (CF).

4. The composite material of claim 3, wherein the sheet comprises about 5% to about 25% of cellulose filaments by weight, based on the total weight of the cellulose filaments, the fillers and the reinforcing fibers.

5. The composite material of claim 4, wherein the sheet comprises at least about 70% of fillers by weight, based on the total weight of the cellulose filaments, the fillers and the reinforcing fibers.

6. The composite material of claim 1, wherein the sheet comprises about 65% to about 90% of fillers by weight, based on the total weight of the fillers and the reinforcing fibers.

7. The composite material of claim 6, wherein the sheet comprises about 1% to about 40% of reinforcing fibers by weight, based on the total weight of the fillers and the reinforcing fibers.

8. The composite material of claim 1, wherein the sheet comprises about 5% to about 40% of reinforcing fibers by weight, based on the total weight of the fillers and the reinforcing fibers.

9. The composite material of claim 6, wherein the sheet comprises about 10% to about 25% of reinforcing fibers by weight, based on the total weight of the fillers and the reinforcing fibers.

10. The composite material of claim 7, wherein the reinforcing fibers are Kraft fibers.

11. The composite material of claim 6, wherein the fillers are chosen from calcium sulfate, clay, calcium carbonate, alumina trihydrate (ATH), magnesium hydroxide (MDH), hollow glass microspheres, exfoliated graphite nano-platelets and mixtures thereof.

12. The composite material of claim 1, wherein the sheet is prepared by a method comprising:
preparing a dry mat comprising a mixture of optional cellulose filaments, the fillers and the reinforcing fibers.

13. The composite material of claim 12, wherein the dry mat has a basis weight of about 100 g/m² to about 300 g/m².

14. The composite material of claim 12, wherein the dry mat has a basis weight of about 300 g/m² to about 2000 g/m².

15. The composite material of claim 12, wherein the dry mat has a basis weight of about 1500 g/m² to about 4000 g/m².

16. The composite material of claim 12, wherein the dry mat is prepared by a method comprising:
draining an aqueous suspension comprising the optional cellulose filaments, the fillers and the reinforcing fibers under conditions to obtain a wet fiber mat;
pressing said wet fiber mat under conditions to remove water and obtain a pressed mat; and
drying said pressed mat under conditions to obtain said dry mat.

17. The composite material of claim 1, wherein the sheet has a 3D geometry and is prepared by a method comprising:
preparing a dry mat comprising a mixture of optional cellulose filaments, the fillers and the reinforcing fibers,
wherein the dry mat is prepared by:
spraying an aqueous suspension comprising the optional cellulose filaments, the fillers and the reinforcing fibers through a perforated 3D mold mounted on a rotatory base and connected to vacuum system for filtration or drainage to obtain a wet pad;
pressing said wet pad under conditions to remove water and obtain a pressed pad; and
drying said pressed pad under conditions to obtain the dry mat

18. The composite material of claim 1, wherein said composite material is a laminate material comprising a plurality of said sheets.

19. The composite material of claim 1, wherein the sheet is a panel or a preform.

20. A method of preparing the composite material of claim 19, the method comprising:
impregnating said panel or preform with resin to obtain a resin-impregnated panel or preform; and
curing the resin under conditions to obtain the composite material.

21. A method of preparing a composite material, the method comprising:
impregnating a plurality of said at least one sheet as defined in claim 1 with resin to obtain a plurality of resin-impregnated sheets;
stacking said plurality of resin-impregnated sheets; and
curing said resin under conditions to obtain said composite material or
stacking a plurality of said at least one sheet as defined in claim 1 to form a stack of sheets;
impregnating said stack of sheets with resin; and
curing said resin under conditions to obtain said composite material.
